(19) United States
(12) Patent Application Publication
(10) Pub. No.: US 2021/0370728 A1
(43) Pub. Date: Dec. 2, 2021

(54) PNEUMATIC TIRE

(71) Applicant: The Yokohama Rubber Co., LTD., Tokyo (JP)

(72) Inventors: Masahiro NARUSE, Kanagawa (JP); Jun MATSUDA, Kanagawa (JP); Takashi HOSHIBA, Kanagawa (JP)

(21) Appl. No.: 17/290,932

(22) PCT Filed: Nov. 12, 2019
(86) PCT No.: PCT/JP2019/044348

§ 371 Date: May 3, 2021

(30) Foreign Application Priority Data
Nov. 21, 2018 (JP) 2018-217939

(51) Int. Cl. B60C 23/04; B60C 5/14

(52) U.S. Cl. CPC B60C 23/0493; B60C 2019/004; B60C 5/14

(57) ABSTRACT

A pneumatic tire includes, on a tire inner surface, at least one housing body made of rubber and configured to accommodate a sensor unit including a sensor for acquiring tire information. The housing body includes an opening portion through which the sensor unit is inserted, and is vulcanization-bonded to the tire inner surface.

### TECHNICAL FIELD

The present technology relates to a pneumatic tire and particularly relates to a pneumatic tire that allows easy insertion work of a sensor unit, and can improve productivity while preventing falling off of the sensor unit.

### BACKGROUND ART

A sensor unit including a sensor for acquiring tire internal information, such as internal pressure or temperature, has been installed in a tire cavity (for example, see Japan Patent No. 6272225 and Japan Unexamined Patent Publication No. 2016-505438). However, when a housing body (container) made of rubber and accommodating a sensor unit is attached to a tire inner surface, an adhesive or adhesive tape is generally used. However, there is a problem in that primer treatment (priming treatment) is required in advance to improve adhesiveness to the tire inner surface, which leads to a problem of poor productivity.

### SUMMARY

The present technology provides a pneumatic tire that allows easy insertion work of a sensor unit, and can improve productivity while preventing falling off of the sensor unit.

A pneumatic tire according to an embodiment of the present technology includes, on a tire inner surface, at least one housing body made of rubber and configured to accommodate a sensor unit including a sensor for acquiring tire information. The housing body includes an opening portion through which the sensor unit is inserted, and is vulcanization-bonded to the tire inner surface.

Additionally, a pneumatic tire according to an embodiment of the present technology includes, on a tire inner surface, at least one housing body made of rubber and configured to accommodate a sensor unit including a sensor for acquiring tire information. The housing body includes: a rubber layer layered on the tire inner surface and having an outer edge portion vulcanization-bonded to the tire inner surface; a housing portion formed between the rubber layer and the tire inner surface; and an opening portion communicating with the housing portion.

Further, a pneumatic tire according to an embodiment of the present technology includes, on a tire inner surface, at least one housing body made of rubber and configured to accommodate a sensor unit including a sensor for acquiring tire information. The housing body includes: a base portion having a plate-shape and joined to the tire inner surface via a vulcanized adhesive; a tube portion protruding from the base portion; a housing portion formed within the tube portion; and an opening portion communicating with the housing portion.

In an embodiment of the present technology, at least one housing body, which is made of rubber and configured to accommodate a sensor unit including a sensor for acquiring tire information, is provided on a tire inner surface. The housing body has an opening portion through which the sensor unit is inserted, so that the work when inserting the sensor unit into the housing body is easy, and the sensor unit can be securely held and prevented from falling off by tightening the housing body. In addition, since the housing body is vulcanization-bonded to the tire inner surface by vulcanization, it is not necessary to perform a primer treatment required when fixing the housing body by using an adhesive tape or the like, and thus it is possible to improve productivity.

In an embodiment of the present technology, as roughness of the tire inner surface in a fixed region of the housing body, an arithmetic mean height Sa preferably ranges from 0.3 μm to 15.0 μm, and a maximum height Sz preferably ranges from 2.5 μm to 60.0 μm. Thus, the adhesion area of the tire inner surface and the vulcanized adhesive can be increased, and the adhesiveness between the tire inner surface and the housing body can be enhanced effectively. The roughness of the tire inner surface is measured in accordance with ISO (International Organization for Standardization) 25178. The arithmetic mean height Sa is an average of absolute values of a difference in height at respective points to an average surface of the surface, and the maximum height Sz is a distance in a height direction from the highest point to the lowest point on the surface.

In an embodiment of the present technology, a width Lc1 of the opening portion of the housing body and an inner width Lc2 of the bottom surface of the housing body preferably satisfy the relationship Lc1<Lc2. Accordingly, since the width Lc1 of the opening portion is relatively small, it is possible to prevent the sensor unit inserted into the housing body from falling off, and it is possible to provide both the workability when inserting the sensor unit and the holding property of the housing body in a compatible manner.

In an embodiment of the present technology, a width Lc1 of the opening portion of the housing body and a maximum width Lsm of the sensor unit to be inserted into the housing body preferably satisfy a relationship 0.10≤Lc1/Lsm ≤0.95. By appropriately setting a ratio of the width Lc1 of the opening portion to the maximum width Lsm of the sensor unit in this manner, it is possible to effectively prevent the sensor unit from falling off, and it is possible to improve the workability when inserting the sensor unit and the holding property of the housing body.

In an embodiment of the present technology, a width Lc1 of the opening portion and an inner width Lc2 of the bottom surface in the housing body, and a width Ls1 of the upper surface and a width Ls2 of the lower surface in the sensor unit to be inserted into the housing body preferably satisfy the relationship Lc1<Ls1≤Ls2≤Lc2. By appropriately setting the widths of the housing body and the sensor unit in this manner, it is possible to effectively prevent the sensor unit from falling off.

In an embodiment of the present technology, an average thickness of the housing body ranges from 0.5 mm to 5.0 mm. As a result, it is possible to improve the workability when inserting the sensor unit, the holding property of the housing body, and the breaking resistance of the housing body in a well-balanced manner.

In an embodiment of the present technology, a ratio of a height Hc of the housing body in a state where the sensor unit is inserted to a height Hs of the sensor unit to be inserted into the housing body preferably ranges from 0.5 to 1.5. This can effectively prevent the sensor unit from falling off.

In an embodiment of the present technology, a breaking elongation EB of the rubber constituting the housing body preferably ranges from 50% to 900%, and a modulus at 300% elongation of the rubber constituting the housing body preferably ranges from 2 MPa to 15 MPa. As a result, it is possible to improve the workability when inserting the sensor unit, the holding property of the housing body, and the breaking resistance of the housing body in a well-balanced manner. The breaking elongation and the modulus at 300% elongation of the rubber constituting the housing body were measured in accordance with JIS (Japanese Industrial Standard) K6251.

In an embodiment of the present technology, the housing body is preferably disposed on an inner side of a ground contact edge in a tire width direction. Accordingly, in the case of the sensor that detects the wear amount of the tread portion, the sensor in the sensor unit inserted into the housing body can accurately acquire the tire information.

In an embodiment of the present technology, “ground contact edge” refers to an end portion in the tire axial direction of a tire mounted on a regular rim and inflated to a regular internal pressure, and placed vertically on a flat surface with a regular load applied to the tire. “Regular rim” refers to a rim defined by a standard for each tire according to a system of standards that includes standards with which tires comply, and is a “standard rim” defined by the Japan Automobile Tyre Manufacturers Association Inc. (JATMA), a “Design Rim” defined by the Tire and Rim Association, Inc. (TRA), or a “Measuring Rim” defined by the European Tire and Rim Technical Organisation (ETRTO). In a system of standards including standards with which tires comply, “regular internal pressure” refers to air pressure defined by each of the standards for each tire and is “maximum air pressure” defined by JATMA, a maximum value described in the table “TIRE LOAD LIMITS AT VARIOUS COLD INFLATION PRESSURES” defined by TRA, or “INFLATION PRESSURE” defined by ETRTO. However, “regular internal pressure” is 250 kPa in a case where a tire is a tire for a passenger vehicle. “Regular load” is a load defined by a standard for each tire according to a system of standards that includes standards with which tires comply, and is a “maximum load capacity” defined by JATMA, a maximum value described in the table “TIRE LOAD LIMITS AT VARIOUS COLD INFLATION PRESSURES” defined by TRA, or “LOAD CAPACITY” defined by ETRTO. However, “regular load” is a load corresponding to 80% of the load described above in a case where a tire is a tire for a passenger vehicle.

### BRIEF DESCRIPTION OF DRAWINGS

FIG. 1 is a meridian cross-sectional view illustrating one example of a pneumatic tire according to an embodiment of the present technology.

FIG. 2 is a plan view illustrating a housing body attached to the pneumatic tire of FIG. 1.

FIG. 3 is a perspective cross-sectional view illustrating a state in which the sensor unit is inserted into the housing body of FIG. 2.

FIG. 4 is a cross-sectional view illustrating a state in which the sensor unit is inserted into the housing body of FIG. 2.

FIG. 5 is a meridian cross-sectional view illustrating a pneumatic tire according to a modified example of an embodiment of the present technology.

FIG. 6 is a plan view illustrating a housing body attached to the pneumatic tire of FIG. 5.

FIG. 7 is a perspective cross-sectional view illustrating a state in which a sensor unit is inserted into the housing body of FIG. 6.

FIG. 8 is a cross-sectional view illustrating a state in which the sensor unit is inserted into the housing body of FIG. 6.

### DETAILED DESCRIPTION

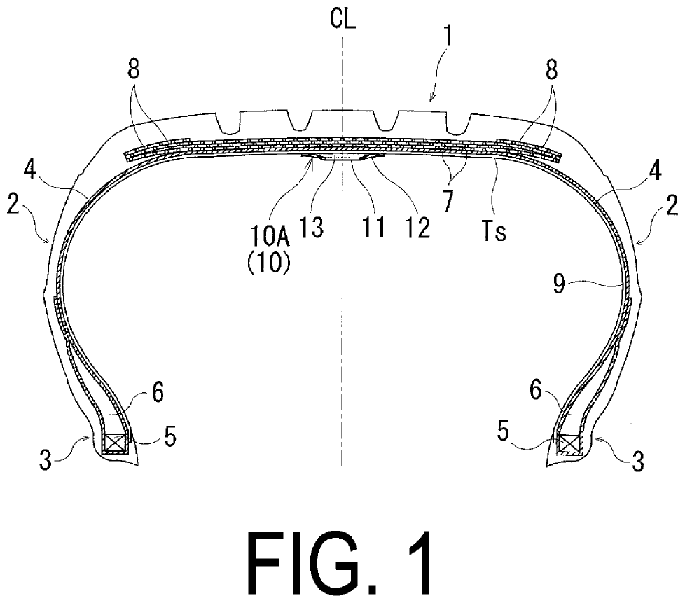

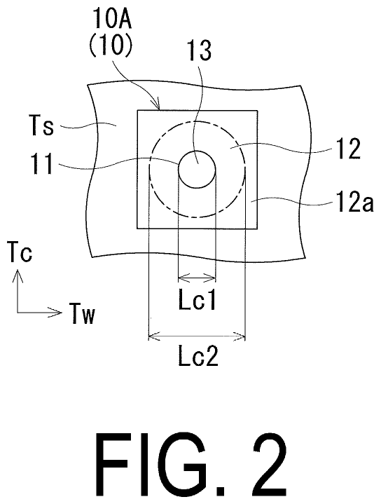

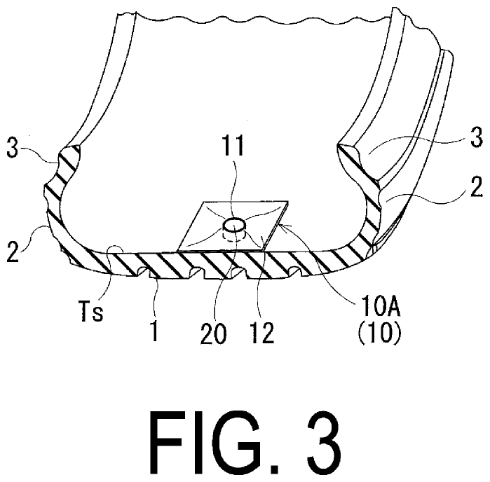

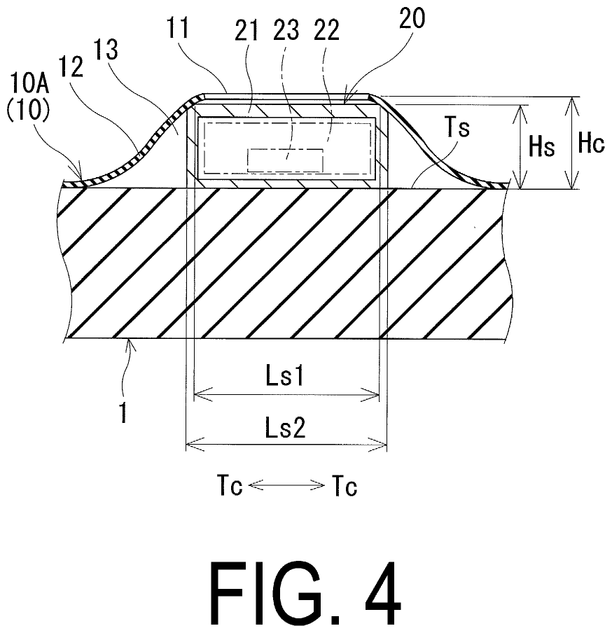

Configurations of embodiments of the present technology will be described in detail below with reference to the accompanying drawings. FIGS. 1 to 4 illustrate a pneumatic tire according to an embodiment of the present technology. In FIGS. 2 and 4, an arrow Tc indicates a tire circumferential direction, and an arrow Tw indicates a tire width direction.

As illustrated in FIG. 1, a pneumatic tire according to an embodiment of the present technology includes an annular tread portion 1 extending in the tire circumferential direction, a pair of sidewall portions 2, 2 respectively disposed on both sides of the tread portion 1, and a pair of bead portions 3, 3 each disposed on an inner side of the sidewall portions 2 in a tire radial direction.

A carcass layer 4 is mounted between the pair of bead portions 3, 3. The carcass layer 4 includes a plurality of reinforcing cords extending in the tire radial direction and is folded back around a bead core 5 disposed in each of the bead portions 3 from a tire inner side to a tire outer side. A bead filler 6 having a triangular cross-sectional shape and formed of a rubber composition is disposed on the outer circumference of the bead core 5. Furthermore, an innerliner layer 9 is disposed in a region between the pair of bead portions 3, 3 on a tire inner surface Ts. The innerliner layer 9 forms the tire inner surface Ts.

On the other hand, a plurality of belt layers 7 are embedded on the outer circumferential side of the carcass layer 4 in the tread portion 1. Each of the belt layers 7 includes a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall within a range of from 10° to 40°, for example. Steel cords are preferably used as the reinforcing cords of the belt layers 7. To improve high-speed durability, at least one belt cover layer 8, formed by disposing reinforcing cords at an angle of, for example, not greater than 5° with respect to the tire circumferential direction, is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

In the pneumatic tire described above, at least one housing body 10 made of rubber is fixed in a region corresponding to the tread portion 1 of the tire inner surface Ts. The housing body 10 accommodates a sensor unit 20 for acquiring tire information. The housing body 10 has an opening portion 11 through which the sensor unit 20 is inserted, and is vulcanization-bonded to the tire inner surface Ts. The housing body 10 preferably expands and contracts when the sensor unit 20 is inserted and removed from the opening portion 11 because the housing body 10 is made of rubber.

Examples of the material of the housing body 10 include chloroprene rubber (CR), butyl rubber (IIR), natural rubber (NR), acrylonitrile-butadiene copolymer rubber (NBR), butadiene rubber (BR), styrene-butadiene rubber (SBR), or the like, and a single material or a blend of two or more materials can be used. Since these materials are excellent in adhesiveness to butyl rubber constituting the tire inner surface Ts, when the housing body 10 is formed of the above materials, sufficient adhesiveness between the housing body 10 and the tire inner surface Ts can be secured.

As illustrated in FIGS. 2 to 4, the housing body 10A (10) has at least one rubber layer 12 structure layered on the tire inner surface Ts. The outer edge portion 12a of the rubber layer 12 is vulcanization-bonded to the tire inner surface Ts. A housing portion 13 for accommodating the sensor unit 20 is formed between the rubber layer 12 and the tire inner surface Ts, and a housing portion 13 communicates with an opening portion 11 having a circular shape. The housing portion 13 is concentric with the opening portion 11 and has a circular planar shape. Thus, the housing portion 13 has a substantially trapezoidal cross-sectional shape with the tire inner surface Ts as a bottom surface and the opening portion 11 as an upper surface. A cylindrical sensor unit 20 having a tapered upper surface is accommodated in the housing portion 13.

In the embodiment of FIGS. 1 to 4, an example in which the housing body 10A is formed of one rubber layer 12 is illustrated, but the housing body 10A may be formed of a plurality of rubber layers 12. In this case, the rubber layer 12 closer to the tire inner surface Ts is preferably formed so as to have a longer length in the tire circumferential direction and the tire width direction, and the housing body 10A is preferably formed in a stepped shape. When the rubber layer 12 is composed of a plurality of layers in this manner, the rubber layer 12 may include a layer whose entire surface is vulcanization-bonded to the tire inner surface Ts. In addition, in the embodiment of FIGS. 1 to 4, an example in which both the opening portion 11 and the housing portion 13 have a circular planar shape is illustrated, but the shape is not particularly limited and can be appropriately changed according to the shape of the sensor unit 20 to be inserted into the housing body 10A. For example, when the shape of the sensor unit 20 is a rectangular parallelepiped or a cube, the planar shape of the opening portion 11 and the housing portion 13 can be formed into a substantially quadrangle shape in accordance therewith. Furthermore, although an example in which the rubber layer 12 (outer edge portion 12a) has a quadrangular planar shape has been described, the planar shape of the rubber layer 12 (outer edge portion 12a) is not particularly limited, and a circular shape, another polygonal shape, or the like may be employed as the planar shape of the rubber layer 12 (outer edge portion 12a).

In a case of manufacturing a pneumatic tire having the housing body 10A on the tire inner surface Ts, in the process for molding the green tire, the housing body 10A integrally joined to the tire inner surface Ts can be formed by layering the rubber layer 12 on the innerliner layer 9 positioned on the tire innermost surface and vulcanizing the green tire by the vulcanizer. For example, when the rubber layer 12 is layered on the innerliner layer 9 (tire inner surface Ts), a member composed of a non-adhesive material that is shorter than the rubber layer 12 in the tire circumferential direction and the tire width direction and does not adhere to the rubber composition (hereinafter referred to as a non-adhesive member) is inserted between the tire inner surface Ts and the rubber layer 12, and such a green tire is vulcanized to form the housing body 10A integrally joined to the tire inner surface Ts. It is not always required to remove the non-adhesive member after the green tire is vulcanized, but by removing the non-adhesive member, the housing body 10A becomes a state in which the sensor unit 20 can be inserted. The opening portion 11 can be formed by using a non-adhesive member having a convex portion corresponding to the opening portion 11 or by forming a hole in the rubber layer 12 of the vulcanized pneumatic tire.

As illustrated in FIG. 4, the sensor unit 20 includes a housing 21 and an electronic component 22. The housing 21 has a hollow structure, and accommodates the electronic component 22 inside. The electronic component 22 includes a sensor 23 that acquires tire information, a transmitter, a receiver, a control circuit, a battery, or the like as appropriate. Examples of the tire information acquired by the sensor 23 include internal temperature and internal pressure of the pneumatic tire, and a wear amount of the tread portion 1, or the like. For example, in a case where a temperature sensor or a pressure sensor is used to measure internal temperature or internal pressure. In a case where a wear amount of the tread portion 1 is detected, a piezoelectric sensor that comes into contact with the tire inner surface Ts can be used as the sensor 23, and the piezoelectric sensor detects an output voltage corresponding to the tire deformation of a tire during traveling, and detects a wear amount of the tread portion 1 based on the output voltage. Moreover, an acceleration sensor or a magnetic sensor can also be used. Additionally, the sensor unit 20 is configured to transmit the tire information acquired by the sensor 23 to an outside of the tire. Further, in order to make it easy to hold the sensor unit 20, a knob portion 24 (not illustrated) protruding from the housing 21 may be provided, and the knob portion 24 can have a function of an antenna. Note that the internal structure of the sensor unit 20 illustrated in FIG. 4 is an example of the sensor unit, and is not limited to this.

The above-described pneumatic tire includes, on a tire inner surface Ts, at least one housing body 10A (10) made of rubber and configured to accommodate a sensor unit 20. The housing body 10A (10) includes: a rubber layer 12 layered on the tire inner surface Ts and having an outer edge portion 12a vulcanization-bonded to the tire inner surface Ts; a housing portion 13 formed between the rubber layer 12 and the tire inner surface Ts; and an opening portion 11 communicating with the housing portion 13. Accordingly the work when inserting the sensor unit 20 into the housing body 10A is easy, and the sensor unit 20 can be securely held and prevented from falling off by tightening the housing body 10A. In addition, since the housing body 10A is vulcanization-bonded to the tire inner surface Ts, it is not required to perform primer treatment which is necessary when the housing body is fixed using an adhesive tape or the like, and thus it is possible to improve productivity.

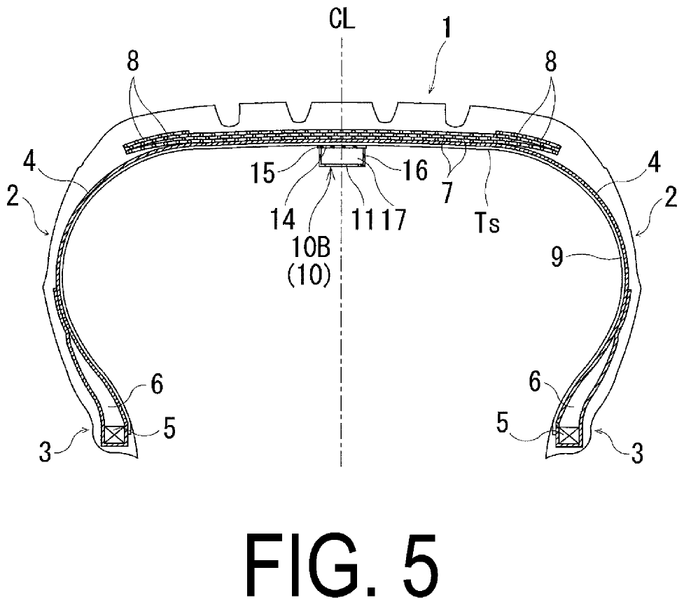

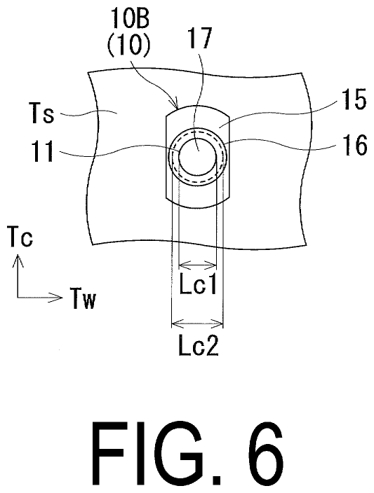

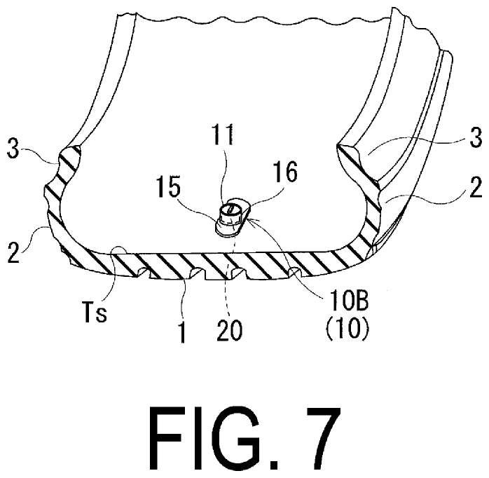

FIG. 5 illustrates a pneumatic tire according to a modified example of an embodiment of the present technology. As illustrated in FIG. 5, the housing body 10B (10) is bonded to the tire inner surface Ts via a vulcanized adhesive 14. As illustrated in FIGS. 6 to 8, the housing body 10B includes a base portion 15 having a plate-shape and joined to the tire inner surface Ts, a cylindrical tube portion 16 protruding from the base portion 15, and a housing portion 17 formed in the tube portion 16. The housing portion 17 communicates with the circular opening portion 11. Thus, the housing portion 17 has a substantially quadrangle cross-sectional shape with the base portion 15 as a bottom surface and the opening portion 11 as an upper surface. A cylindrical sensor unit 20 having a tapered upper surface is accommodated in the housing portion 17.

Note that the shapes of the base portion 15, the tube portion 16, and the housing portion 17 are not particularly limited, and can be appropriately changed according to the shape of the sensor unit 20 to be inserted into the housing body 10B.

The vulcanized adhesive 14 is not particularly limited as long as it can bond the rubber composition. Examples thereof include an adhesive that is naturally vulcanized (vulcanizable at normal temperature) and a puncture repair agent used as an emergency treatment when a pneumatic tire is punctured.

When manufacturing a pneumatic tire having a housing body 10B on a tire inner surface Ts, a vulcanized pneumatic tire is subjected to any treatment such as cutting (so-called buffing), laser treatment, or plasma treatment, and then a vulcanized adhesive 14 is applied to the treated tire inner surface Ts, and the housing body 10B is disposed on the vulcanized adhesive 14. The above-described treatment is different from the primer treatment, and is a treatment that takes a shorter time required than the primer treatment.

The above-described pneumatic tire includes, on the tire inner surface Ts, at least one housing body 10B (10) made of rubber and configured to accommodate a sensor unit 20. The housing body 10B (10) includes: a base portion 15 having a plate-shape and joined to the tire inner surface Ts via a vulcanized adhesive 14; a tube portion 16 protruding from the base portion 15; a housing portion 17 formed within the tube portion 16; and an opening portion 11 communicating with the housing portion 17. Accordingly the work when inserting the sensor unit 20 into the housing body 10B is easy, and the sensor unit 20 can be securely held and prevented from falling off by tightening the housing body 10B. In addition, since the housing body 10B is vulcanization-bonded to the tire inner surface Ts, it is not required to perform primer treatment which is necessary when the housing body is fixed using an adhesive tape or the like, and thus it is possible to improve productivity.

In the pneumatic tire, as roughness of the tire inner surface Ts in a fixed region of the housing body 10B, an arithmetic mean height Sa preferably ranges from 0.3 μm to 15.0 μm, and a maximum height Sz preferably ranges from 2.5 μm to 60.0 μm. By appropriately setting the arithmetic mean height Sa and the maximum height Sz as the roughness of the tire inner surface Ts inner surface Ts in this manner, the adhesion area of the tire inner surface Ts and the vulcanized adhesive 14 can be increased, and the adhesiveness between the tire inner surface Ts and the housing body 10B can be enhanced effectively. When the arithmetic mean height Sa exceeds 15.0 μm and the maximum height Sz exceeds 60.0 μm, the vulcanized adhesive 14 cannot follow the unevenness of the tire inner surface Ts, and the adhesiveness tends to decrease. Note that the arithmetic mean height Sa and the maximum height Sz are values measured in accordance with ISO25178, and can be measured using a commercially available surface properties measuring machine (e.g., a shape analysis laser microscope or a 3D shape measuring machine). The measurement method may be any of a contact type or a non-contact type.

In FIGS. 1 and 5, the housing bodies 10A and 10B (10) are disposed on an inner side of the ground contact edge in the tire width direction. In the case of the sensor 23 that detects the wear amount of the tread portion 1, the sensor 23 in the sensor unit 20 inserted into the housing body 10 can accurately acquire the tire information.

In the above-described pneumatic tire, the housing body 10 may be set to have the following dimensions. A width Lc1 of the opening portion 11 of the housing body 10 and an inner width Lc2 of the bottom surface of the housing body 10 preferably satisfy the relationship Lc1<Lc2. By making the width Lc1 of the opening portion 11 narrower than the inner width Lc2 of the bottom surface of the housing body 10 in this manner, the restricting force on the upper surface side of the housing body 10 is strengthened, and the sensor unit 20 inserted into the housing body 10 can be effectively prevented from falling off. Accordingly, both workability when inserting the sensor unit 20 and a holding property of the housing body 10 can be provided in a compatible manner. Both the width Lc1 of the opening portion 11 and the inner width Lc2 of the bottom surface of the housing body 10 are measured in a state where the sensor unit 20 is not inserted into the housing body 10.

Additionally, the average thickness of the housing body 10 preferably ranges from 0.5 mm to 5.0 mm. By appropriately setting the average thickness of the housing body 10 in this manner, it is possible to improve the workability when inserting the sensor unit 20, the holding property of the housing body 10, and the breaking resistance of the housing body 10 in a well-balanced manner. Here, when the average thickness of the housing body 10 is thinner than 0.5 mm, the housing body 10 is easily broken when the sensor unit 20 is inserted. When the average thickness of the housing body 10 is thicker than 5.0 mm, the rigidity of the housing body 10 becomes excessively large, and the sensor unit 20 cannot be easily inserted. The average thickness of the housing body 10 is obtained by measuring the thickness of the rubber constituting the housing body 10. When the housing body 10A is composed of a plurality of rubber layers 12, the total thicknesses of the rubber layers 12 are measured.

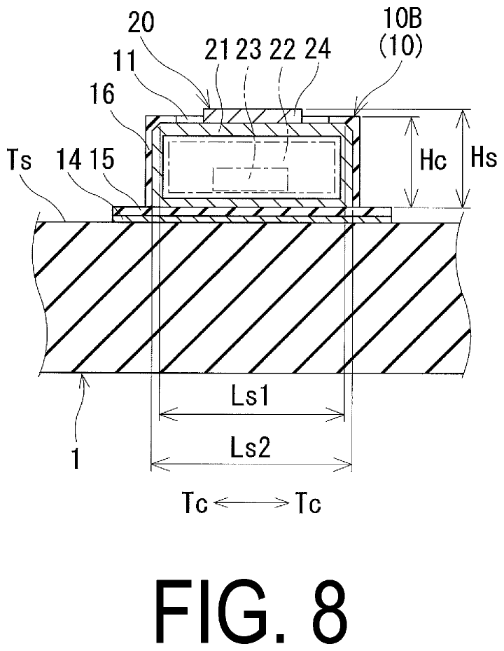

In particular, the housing body 10 and the sensor unit 20 preferably satisfy the following dimensional relationship. The width Lc1 of the opening portion 11 of the housing body 10 and the maximum width Lsm of the sensor unit 20 to be inserted into the housing body 10 preferably satisfy the relationship 0.10≤Lc1/Lsm≤0.95, more preferably satisfy the relationship 0.15≤Lc1/Lsm≤0.80, and most preferably satisfy the relationship 0.15≤Lc1/Lsm≤0.65. By appropriately setting the ratio of the width Lc1 of the opening portion 11 of the housing body 10 to the maximum width Lsm of the sensor unit 20 in this manner, it is possible to effectively prevent the sensor unit 20 from falling off, and it is possible to improve the workability when inserting the sensor unit 20 and the holding property of the housing body 10. In the sensor unit 20 illustrated in FIGS. 4 and 8, the maximum width Lsm corresponds to the width Ls2 of the lower surface.

In addition, the width Lc1 of the opening portion 11 and the inner width Lc2 of the bottom surface in the housing body 10, and the width Ls1 of the upper surface and the width Ls2 of the lower surface in the sensor unit 20 to be inserted into the housing body 10 preferably satisfy the relationship Lc1<Ls1≤Ls2≤Lc2. Further, the upper surface of the sensor unit 20 is formed in a tapered shape so as to preferably satisfy the relationship Ls1<Ls2. By appropriately setting the widths of the housing body 10 and the sensor unit 20 in this manner, it is possible to effectively prevent the sensor unit 20 from falling off.

Furthermore, the ratio of the height Hc of the housing body 10 in the state where the sensor unit 20 is inserted to the height (maximum height) Hs of the sensor unit 20 to be inserted into the housing body 10 preferably ranges from 0.5 to 1.5, more preferably ranges from 0.6 to 1.3, and most preferably ranges from 0.7 to 1.0. By appropriately setting the ratio of the height Hc of the housing body 10 to the height Hs of the sensor unit 20 in this manner, it is possible to effectively prevent the sensor unit 20 from falling off. The height Hs of the sensor unit 20 is a height including the knob portion 24 when the knob portion 24 is provided in the sensor unit 20 (see FIG. 8). In addition, in the case of the housing body 10A, the height Hc is a height between the tire inner surface Ts and the end portion positioned on an outer side in the tire radial direction of the rubber layer 12 adjacent to the tire inner surface Ts (see FIG. 4). On the other hand, in the case of the housing body 10B, the height Hc does not include the height of the base portion 15 but is the height of the tube portion 16 (see FIG. 8).

In the above-described pneumatic tire, the rubber constituting the housing body 10 preferably has the following physical properties. The breaking elongation EB preferably ranges from 50% to 900%, and the modulus at 300% elongation (M300) preferably ranges from 2 MPa to 15 MPa. By appropriately setting the breaking elongation EB and the modulus (M300) in this manner, it is possible to improve the workability when inserting the sensor unit 20, the holding property of the housing body 10, and the breaking resistance of the housing body 10 in a well-balanced manner.

### EXAMPLES

Tires according to Examples 1 to 7 were manufactured. The tires have a tire size of 275/40R21 and include, on the tire inner surface, at least one housing body made of rubber and configured to accommodate a sensor unit including a sensor for acquiring tire information. The tires are set for the housing body structure, the bonding structure of the housing body to the tire inner surface, and the ratio (Lc1/Lsm) of the width Lc1 of the opening portion to the maximum width Lsm of the sensor unit as indicated in Table 1.

For comparison, a tire according to a Conventional Example was prepared in which a housing body was not provided on the tire inner surface. In addition, tires according to Comparative Examples 1 to 3 were prepared in which a housing body having the structure of FIG. 8 was provided on the tire inner surface, but primer treatment was performed before fixing the housing body to the tire inner surface, and the adhesive structure was different from those of Examples 1 to 7. Specifically, in the tire of Comparative Example 1, the housing body is fixed via a double-sided tape, in the tire of Comparative Example 2, the housing body is fixed via an instantaneous adhesive, and in the tire of Comparative Example 3, the housing body is fixed via a reaction curing adhesive.

The test tires were evaluated for productivity, workability when inserting the sensor unit, and durability by a test method described below. The results of the evaluation are also indicated in Table 1.

Productivity:

For each test tire, the time required for the manufacturing process including molding, vulcanization, installation of the housing body, and inspection was measured. The evaluation results are expressed as index values with Conventional Example being assigned the value of 100. Smaller index values indicate superior productivity. The time required does not include a working time for inserting the sensor unit into the housing body provided on the tire inner surface.

Workability when inserting sensor unit:

For each test tire except for the tire of the Conventional Example, the time required for the work of inserting the sensor unit into the housing body provided on the tire inner surface was measured. The evaluation results are expressed as index values with Comparative Example 1 being assigned the value of 100 by using reciprocals of the measurement values. Larger index values indicate easier work for inserting the sensor unit.

Durability:

Each of the test tires was mounted on a wheel having a rim size of 21×9.5J, and a running test was performed by using a drum testing machine at air pressure of 120 kPa, 102% with respect to the maximum load, running speed of 81 km/h, and a running distance of 10000 km. After the test was performed, presence of breakage of the housing body or falling off of the sensor unit was visually observed. The evaluation results indicate the presence or absence of breakage of the housing body and the presence or absence of falling off of the sensor unit.

TABLE 1

| | Conventional | Comparative | Comparative | Comparative |
|---|---|---|---|---|
| | Example | Example 1 | Example 2 | Example 3 |
| Presence of housing | No | Yes | Yes | Yes |
| body | | | | |
| Structure of housing | — | FIG. 8 | FIG. 8 | FIG. 8 |
| body | | | | |
| Adhesive structure of | — | Double- | Instantaneous | Reaction |
| housing body with | | sided tape | adhesive | curing |
| respect to tire inner | | | | adhesive |
| surface | | | | |
| Presence of primer | — | Yes | Yes | Yes |
| treatment on tire inner | | | | |
| surface | | | | |
| Ratio (Lc1/Lsm) of | — | 0.05 | 0.05 | 0.05 |
| width Lc1 of opening | | | | |
| portion to maximum | | | | |
| width Lsm of sensor | | | | |
| unit | | | | |
| Productivity | 100 | 110 | 110 | 115 |
| Workability when | — | 100 | 100 | 100 |
| inserting sensor unit | | | | |
| Durability (presence | — | Yes | Yes | Yes |
| of breakage of | | | | |
| housing body) | | | | |
| Durability (presence | — | No | No | No |
| of falling off of sensor | | | | |
| unit) | | | | |
| | Example 1 | Example 2 | Example 3 | Example 4 |
| Presence of housing | Yes | Yes | Yes | Yes |
| body | | | | |
| Structure of housing | FIG. 4 | FIG. 8 | FIG. 4 | FIG. 4 |
| body | | | | |
| Adhesive structure of | Vulcanization- | Self- | Vulcanization- | Vulcanization- |
| housing body with | bonding | vulcanizing | bonding | bonding |
| respect to tire inner | | adhesive | | |
| surface | | | | |
| Presence of primer | No | No | No | No |
| treatment on tire | | | | |
| inner surface | | | | |
| Ratio (Lc1/Lsm) of | 0.05 | 0.05 | 0.10 | 0.50 |
| width Lc1 of opening | | | | |
| portion to maximum | | | | |
| width Lsm of sensor | | | | |
| unit | | | | |
| Productivity | 100 | 105 | 100 | 100 |
| Workability when | 100 | 100 | 101 | 103 |
| inserting sensor unit | | | | |
| Durability (presence | Yes | Yes | No | No |
| of breakage of | | | | |
| housing body) | | | | |
| Durability (presence | No | No | No | No |
| of falling off of | | | | |
| sensor unit) | | | | |

| | Example 5 | Example 6 | Example 7 |
|---|---|---|---|
| Presence of housing body | Yes | Yes | Yes |
| Structure of housing body | FIG. 4 | FIG. 8 | FIG. 4 |
| Adhesive structure of | Vulcanization- | Self- | Vulcanization- |
| housing body with respect | bonding | vulcanizing | bonding |
| to tire inner surface | | adhesive | |
| Presence of primer | No | No | No |
| treatment on tire inner | | | |
| surface | | | |
| Ratio (Lc1/Lsm) of width | 0.90 | 0.90 | 0.95 |
| Lc1 of opening portion to | | | |
| maximum width Lsm of | | | |
| sensor unit | | | |
| Productivity | 100 | 105 | 100 |
| Workability when inserting | 105 | 105 | 106 |
| sensor unit | | | |
| Durability (presence of | No | No | No |
| breakage of housing body) | | | |
| Durability (presence of | No | No | Yes |
| falling off of sensor unit) | | | |

As can be seen from Table 1, the pneumatic tires of Examples 1 to 7 have maintained the productivity as compared with the Conventional Example. The pneumatic tires of Examples 3 to 7 have improved the workability when inserting the sensor unit as compared with Comparative Example 1. The pneumatic tires of Examples 3 to 6 had no breakage of the housing body and no detachment of the sensor unit.

On the other hand, the pneumatic tires of Comparative Examples 1 to 3 had deteriorated productivity since the primer treatment was performed before the housing body was fixed to the tire inner surface.

1. A pneumatic tire, comprising:
on a tire inner surface, at least one housing body made of rubber and configured to accommodate a sensor unit comprising a sensor for acquiring tire information,
the housing body comprising an opening portion through which the sensor unit is inserted, and the housing body being vulcanization-bonded to the tire inner surface.

2. A pneumatic tire, comprising:
on a tire inner surface, at least one housing body made of rubber and configured to accommodate a sensor unit comprising a sensor for acquiring tire information,
the housing body comprising:
a rubber layer layered on the tire inner surface and having an outer edge portion vulcanization-bonded to the tire inner surface;
a housing portion formed between the rubber layer and the tire inner surface; and
an opening portion communicating with the housing portion.

3. A pneumatic tire, comprising
on a tire inner surface, at least one housing body made of rubber and configured to accommodate a sensor unit comprising a sensor for acquiring tire information,
the housing body comprising:
a base portion having a plate-shape and joined to the tire inner surface via a vulcanized adhesive;
a tube portion protruding from the base portion;
a housing portion formed within the tube portion; and
an opening portion communicating with the housing portion.

4. The pneumatic tire according to claim 3, wherein
as roughness of the tire inner surface in a fixed region of the housing body, an arithmetic mean height Sa ranges from 0.3 μm to 15.0 μm, and a maximum height Sz ranges from 2.5 μm to 60.0 μm.

5. The pneumatic tire according to claim 1, wherein
a width Lc1 of the opening portion of the housing body and an inner width Lc2 of a bottom surface of the housing body satisfy a relationship Lc1<Lc2.

6. The pneumatic tire according to claim 1, wherein
a width Lc1 of the opening portion of the housing body and a maximum width Lsm of the sensor unit to be inserted into the housing body satisfy a relationship 0.10≤Lc1/Lsm≤0.95.

7. The pneumatic tire according to claim 1, wherein
a width Lc1 of the opening portion and an inner width Lc2 of a bottom surface in the housing body, and a width Ls1 of an upper surface and a width Ls2 of a lower surface in the sensor unit to be inserted into the housing body, satisfy a relationship Lc1<Ls≤Ls2≤Lc2.

8. The pneumatic tire according to claim 1, wherein
an average thickness of the housing body ranges from 0.5 mm to 5.0 mm.

9. The pneumatic tire according to claim 1, wherein
a ratio of a height Hc of the housing body in a state where the sensor unit is inserted to a height Hs of the sensor unit to be inserted into the housing body ranges from 0.5 to 1.5.

10. The pneumatic tire according to claim 1, wherein
a breaking elongation EB of the rubber constituting the housing body ranges from 50% to 900%, and a modulus at 300% elongation of the rubber constituting the housing body ranges from 2 MPa to 15 MPa.

11. The pneumatic tire according to claim 1, wherein
the housing body is disposed on an inner side of a ground contact edge in a tire width direction.

12. The pneumatic tire according to claim 2, wherein
a width Lc1 of the opening portion of the housing body and an inner width Lc2 of a bottom surface of the housing body satisfy a relationship Lc1<Lc2.

13. The pneumatic tire according to claim 2, wherein
a width Lc1 of the opening portion of the housing body and a maximum width Lsm of the sensor unit to be inserted into the housing body satisfy a relationship 0.10≤Lc1/Lsm≤0.95.

14. The pneumatic tire according to claim 2, wherein
a width Lc1 of the opening portion and an inner width Lc2 of a bottom surface in the housing body, and a width Ls1 of an upper surface and a width Ls2 of a lower surface in the sensor unit to be inserted into the housing body, satisfy a relationship Lc1<Ls1≤Ls2≤Lc2.

15. The pneumatic tire according to claim 2, wherein
an average thickness of the housing body ranges from 0.5 mm to 5.0 mm.

16. The pneumatic tire according to claim 2, wherein
a ratio of a height Hc of the housing body in a state where the sensor unit is inserted to a height Hs of the sensor unit to be inserted into the housing body ranges from 0.5 to 1.5.

17. The pneumatic tire according to claim 2, wherein
a breaking elongation EB of the rubber constituting the housing body ranges from 50% to 900%, and a modulus at 300% elongation of the rubber constituting the housing body ranges from 2 MPa to 15 MPa.

18. The pneumatic tire according to claim 2, wherein
the housing body is disposed on an inner side of a ground contact edge in a tire width direction.

19. The pneumatic tire according to claim 3, wherein
a width Lc1 of the opening portion of the housing body and an inner width Lc2 of a bottom surface of the housing body satisfy a relationship Lc1<Lc2.

20. The pneumatic tire according to claim 3, wherein
a width Lc1 of the opening portion of the housing body and a maximum width Lsm of the sensor unit to be inserted into the housing body satisfy a relationship 0.10≤Lc1/Lsm≤0.95.
